(19) United States
(12) Patent Application Publication
(10) Pub. No.: US 2014/0142777 A1
(43) Pub. Date: May 22, 2014

(54) POWER AUTOMATION INSTALLATION AND METHOD FOR OPERATING A POWER AUTOMATION INSTALLATION

(71) Applicants: Henry Dawidczak, Petersaurach (DE); Thierry Dufaure, Berlin (DE); Heiko Englert, Burgthann (DE)

(72) Inventors: Henry Dawidczak, Petersaurach (DE); Thierry Dufaure, Berlin (DE); Heiko Englert, Burgthann (DE)

(21) Appl. No.: 14/003,960

(22) PCT Filed: Mar. 9, 2011
(86) PCT No.: PCT/EP2011/053524

§ 371 Date: Sep. 27, 2013

(51) Int. Cl. H02J 4/00

(52) U.S. Cl. CPC H02J 4/00
USPC 700/295

(57) ABSTRACT

In order to simplify and design the configuration in particular of a power automation installation with a comparatively high number of power automation devices in such a way that as far as possible no interruption of operation is necessary, a method for operating a power automation installation is proposed, wherein the power automation installation includes a plurality of power automation devices and at least one higher-level installation control device for controlling and/or monitoring the power automation devices. An additional power automation device is connected to the concentrator device and automatic configuration of the concentrator device is carried out by the incorporation of a device description file of the additional power automation device into a concentrator data model of the concentrator device. There is also provided a corresponding power automation installation.

The invention relates to a method for operating a power automation installation which comprises a plurality of power automation devices and at least one higher-level installation control device for controlling and/or monitoring the power automation devices as well as a corresponding power automation installation.

The operation of electrical power supply networks is controlled by so-called power automation installations. These ordinarily have one or more higher-level installation control devices (e.g. so-called energy management systems which are provided in grid control centers) which are connected to several power automation devices (also referred to as IED=“Intelligent Electronic Devices”) and can control and/or monitor them to guarantee the operation of the power supply network.

While the function of power automation installations in the past was generally limited for a classic operation of the power supply networks to the control and monitoring of switchgear assemblies and/or electrical substations at the high voltage or medium voltage level, for future operational modes of the power supply networks controls and monitors of the distribution grids at medium and low voltage level (also summarized under the general term “Smart Grid Applications”) are being integrated into the automation, in order for example to be able to carry out so-called “Demand Response Functions”, that is a direct or indirect influence of the end consumers in the power supply network.

One example of such a power automation installation can be taken from WO 2008/148418 A1, in which an energy distribution device is connected to a plurality of energy consuming devices via so-called ballasts and said energy consuming devices are influenced via varying energy loss conditions with respect to their consumption behavior.

In scenarios for future smart grid applications it is assumed that in the electrical distribution grid the interaction of a plurality of electrical consumers and producers or combined producers/consumers (so-called prosumers) arranged in the low voltage and medium voltage network is controlled by intelligent working energy management systems. To this end it is necessary that power automation devices assigned to consumers, producers and prosumers on the one hand and the energy management systems on the other hand exchange information relevant for the operation of the power supply network via communications networks. For example the communications IEC 61850 standard can be used for the exchange of data. This standard is already being used extensively today in switchgear automation, for example as can be inferred from WO 2010/034335 A1.

Vis-à-vis switchgear automation, the application scenarios for distribution grid management differ among other things in that the number of power automation devices which are assigned to an installation control device (an energy management system), due to the great quantity of consumers, producers and prosumers on the distribution grid level, is several magnitudes higher (circa 10,000-1,000,000 devices) than in switchgear automation (circa 10-100 devices). In addition, configuration changes, in particular by adding or removing power automation devices, take place significantly more frequently in the case of distribution grid management (up to several times daily) than in the case of switchgear automation (circa once annually).

In order to secure the proper operation of a power automation installation, all units of the power automation installation, thus the power automation devices and the installation control device, must be set up by corresponding configuration settings. In particular the configuration of the installation control device must completely mirror the power automation devices in the power automation installation as well as their functions and settings.

In hitherto existing switchgear automation, the configuration of the installation control device takes place manually. In particular due to the manageable number of power automation devices in switchgear, this can be performed with a justifiable amount of effort. In connection with the IEC 61850 standard the procedure in the case of such a configuration is described in exemplary fashion in the manual “Ethernet & IEC 61850—Start Up” of Siemens AG, Edition 15 Jun. 2009, order number E50417-F1176-C324-A3, in particular in Chapter 6 “Creating a Project and Structuring It”. In this connection a static configuration is generated with a configuration software program. The adoption of a new configuration by an IEC 61850 device (e.g. the installation control device) takes place by restarting the device or at least the specific function of the IEC 61850 device, which is associated with an interruption of the operation of the entire system. In power automation installations with a comparatively high number of power automation devices a manual configuration is no longer practical.

Therefore the invention is based on the object of simplifying and designing the configuration of a power automation installation, in particular a power automation installation with a comparatively high number of power automation devices such that, where possible, no interruption of operation is necessary.

To solve this object, a method for operation of a power automation installation is proposed that comprises a plurality of power automation devices and at least one higher-level installation control device for controlling and/or monitoring the power automation devices wherein the power automation devices are connected to the installation control device by a concentrator device and a data model file containing a concentrator data model is stored in a memory device of the concentrator device and wherein the concentrator data model comprises information about the power automation devices connected to the concentrator device their functions and settings as well as provides data objects whose states are adapted to the current states of corresponding data objects of the power automation devices. The following steps are carried out in the method:
Connection of an additional power automation device to the concentrator device;
Generation of a communication address for the additional power automation device by the concentrator device and transmission of the communication address to the additional power automation device;
Storage of the communication address in the additional power automation device and use of the communication address for further communication with the concentrator device;
Retrieval of a device description file of the power automation device by the concentrator device, said file specifying the functions and settings of the additional power automation device;
Adaptation of the concentrator data model to the functions and settings of the additional power automation device specified by the device description file; and
Provision of the adapted concentrator data model for the installation control device.

In the case of the inventive method, on the one hand the configuration effort is reduced by provision of the so-called concentrator device, which constitutes a connector between the installation control device and the individual power automation devices both for the communication as well as also for the logical provision of data. In addition, the inventive method makes possible, in an advantageous manner, an automatic configuration of the concentrator data model used for the provision of current state information about the power automation devices by performing an automatic adaptation of the concentrator data model to the functions and settings of the additional power automation device after an automatic address assignment to a newly added power automation device. In this way, on the one hand a configuration of the power automation installation for adaptation to the additional power automation device can be achieved without manual interventions and on the other hand without the necessity of interrupting operation.

The retrieval of the device description file carried out in the case of the inventive method can take place in this connection either via a so-called file transfer (e.g. FTP (FTP=file transfer protocol) or MMS file transfer (MMS=manufacturing messaging specification)). As an alternative to this the provision of a device description file can also take place in the concentrator device via a so-called discovery service. In this connection the concentrator device itself uses a collection service which determines the necessary information for the device description file by individual queries and compiles it into a device description file.

One advantageous embodiment of the inventive method provides that the installation control device records a user input prior to connecting the additional power automation device to the concentrator device, said user input specifying a device code of the additional power automation device, after connection of the additional power automation device to the concentrator device the additional power automation device transmits its device code to the concentrator device, the concentrator device sends the device code transmitted by the additional power automation device to the installation control device, the installation control device checks whether the device code transmitted by the concentrator device matches the device code entered by the user and, in the case of a matching device code sends a confirmation telegram to the concentrator device, and the concentrator device only then retrieves the device description file from the additional power automation device or determines via a discovery service when the confirmation telegram is on hand.

In this way with only slight manual effort, namely the entry on the part of the user of a device code of the additional power automation device, the addition of the additional power automation device can be authorized. In the case of the previously known methods to this end, the entire device description of the additional power automation device would have to be inserted into the database of the installation control device, as a result of which a high configuration effort arises and the flexibility of the power automation installation is restricted. In the manner of the invention it is in addition ensured that no power automation device is added to the power automation installation whose operation is not provided on the part of the user in the automation installation.

A further advantageous embodiment of the inventive method provides that the installation control device comprises an installation data model file containing an installation data model, wherein the installation data model provides information about all power automation devices of the power automation installation whose functions and settings comprise as well as provide data objects, whose states are adapted to the current states of corresponding data objects of the power automation devices, the installation control device adapts its installation data model to the functions and settings of the additional power automation device specified by the expanded concentrator data model, and in the operation of the power automation installation a change of a state of a data object of a power automation device connected to the concentrator device brings about a corresponding change of the states of the corresponding data objects of the concentrator data model and of the installation data model.

In this way, the respective states of the individual power automation devices can be especially easily passed on to the installation control device via the concentrator device. During operation, namely only the data objects of the concentrator data model have to be adapted to the data objects of the power automation devices as well as the data objects of the installation data model of the installation control device to the state of the data objects of the concentrator data model.

According to an advantageous embodiment, in this connection provision is made that the installation control device first checks the information contained in the concentrator data model about functions and settings of the additional power automation device to determine whether said functions and settings are compatible with the installation data model, and only in the event of existing compatibility adapts the installation data model to the concentrator data model and sends an activation telegram to the concentrator device, and that the concentrator device only integrates the additional power automation device in the operation of the power automation installation in the case of an existing activation telegram.

As a result of this it can be ensured that the power automation installation can go into operation with the additional power automation device, since prior to the beginning of operation the compatibility of the data objects of the added power automation device with the installation data model in the installation control device is checked. Only then, when the compatibility in this regard has been ascertained, is the clearance for operation of the additional power automation device given.

According to a further advantageous embodiment of the inventive method, provision is made that in the event of the removal of a power automation device from the power automation installation the concentrator device detects the missing connection to the removed power automation device and adapts its concentrator data model by deleting the entries for the removed power automation device and transmits the adapted concentrator data model to the installation control device, and that the installation control device adapts its installation data model by deleting the entries for the removed power automation device.

In this way, the configuration of the power automation installation can not only be adapted to newly added power automation devices, but rather to removed power automation devices.

A further advantageous embodiment of the inventive method provides that the device description file of the additional power automation device is specified in the form of an ICD file or IID file in accordance with the IEC 61850 standard. In addition, provision can be made that the concentrator data model of the concentrator device is specified in the form of an SCD file in accordance with the IEC 61850 standard, and that the installation data model of the installation control device is specified in the form of an SCD file in accordance with the IEC 61850 standard.

The IEC 61850 standard meanwhile has become a widespread, tried and tested standard for communication in switchgear of power supply systems and is therefore well suited for being used also in the inventive method. ICD, IID and SCD constitute description files in accordance with IEC 61850 which are created using the SCL description language (substation configuration language).

Vis-à-vis the installation control device the concentrator device is represented in turn, when SCL-based, as ICD or IID. In the adjustment of the subordinate power automation devices the configuration file can be specified in the concentrator device as SCD description.

The object cited above is finally also solved by a power automation installation with a plurality of power automation devices of at least one installation control device for controlling and/or monitoring the power automation devices, wherein the power automation devices are connected to the control device via a concentrator device. In accordance with the invention the power automation installation is set up for carrying out a method in accordance with any one of claims 1 through 8.

The invention will be explained in greater detail in the following with reference to exemplary embodiments. The figures show the following:

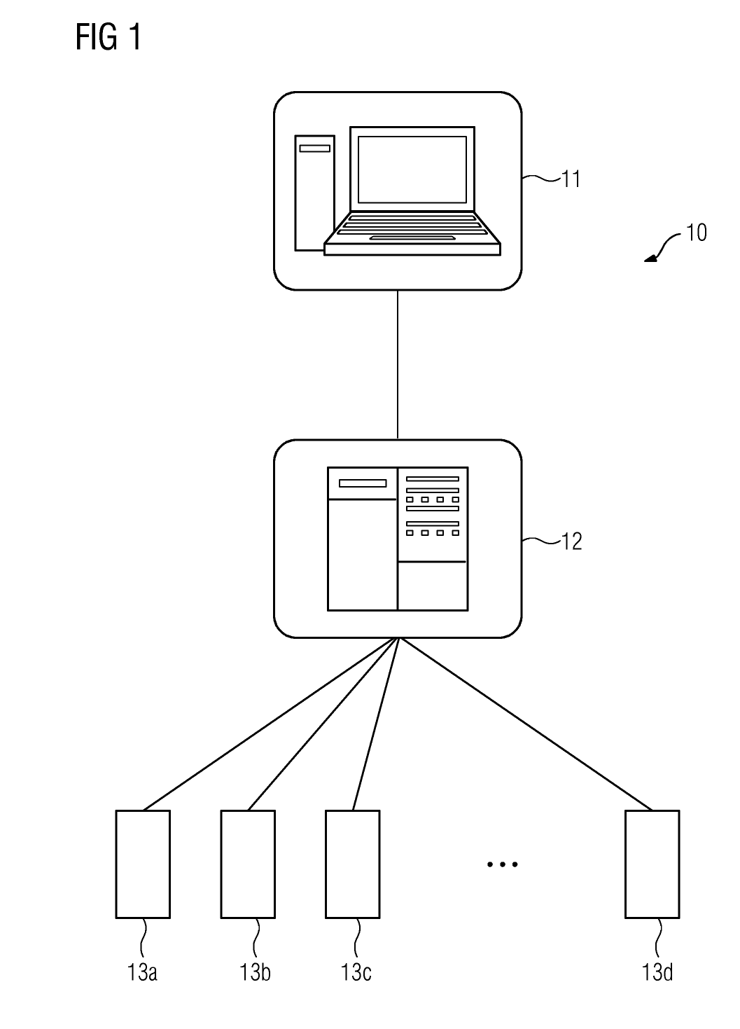

FIG. 1 shows a schematic view of a first exemplary embodiment of a power automation installation,

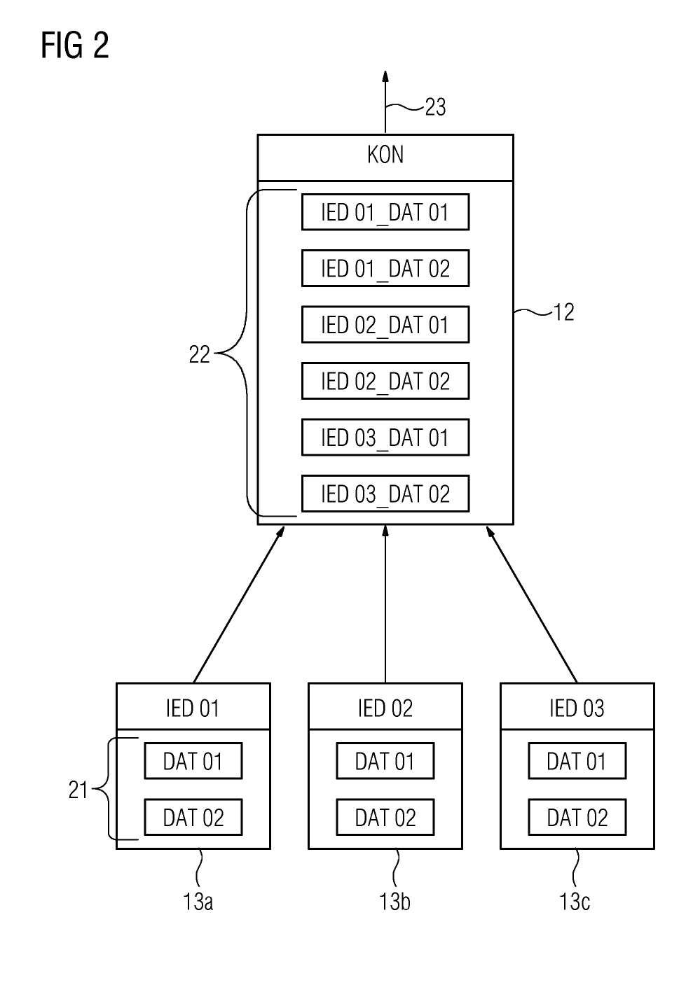

FIG. 2 shows an explanation of how a concentrator data model works,

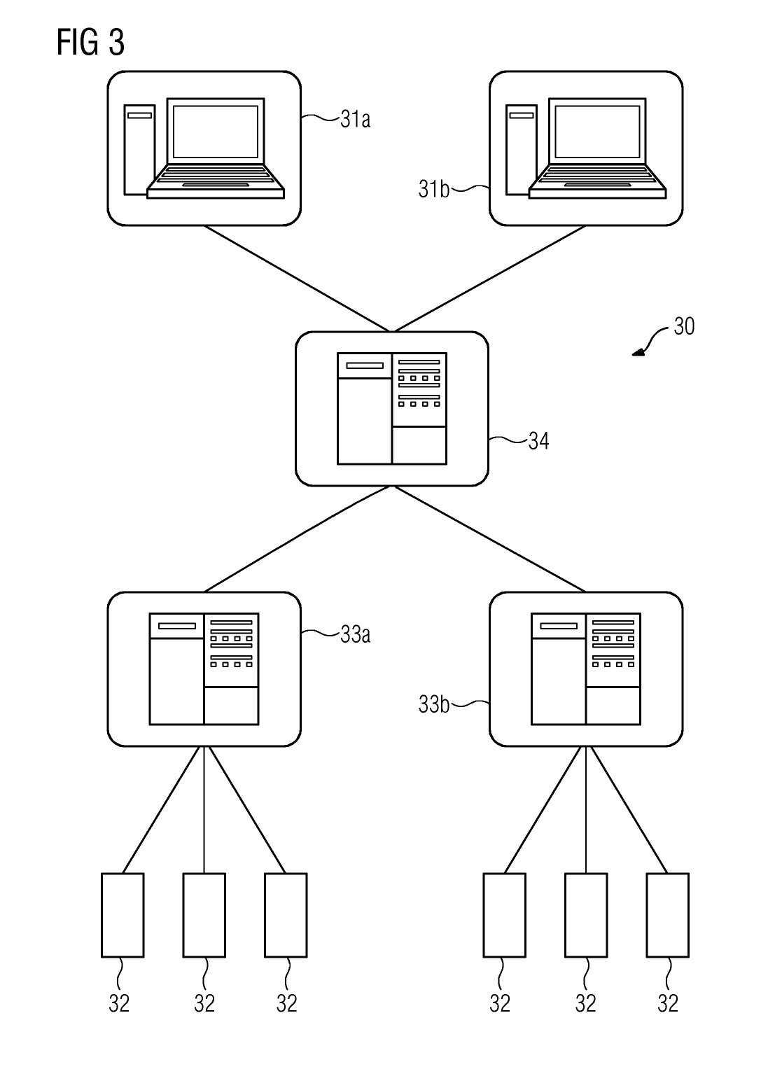

FIG. 3 shows a schematic view of a second exemplary embodiment of a power automation installation,

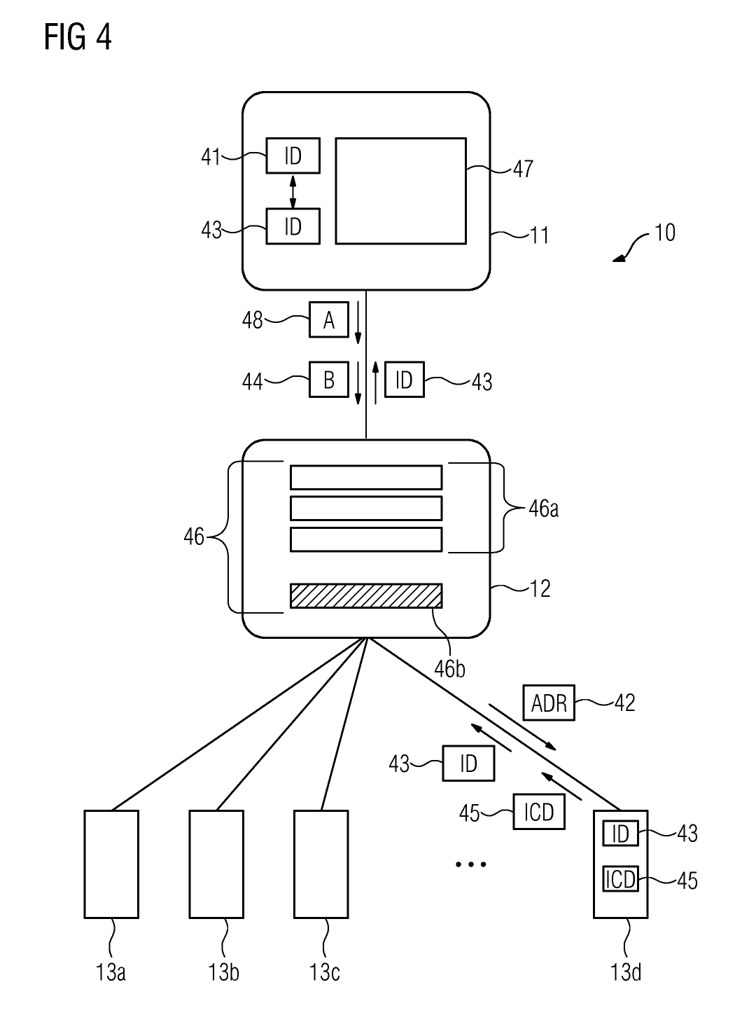

FIG. 4 shows a block diagram of the power automation installation according to FIG. 1 for explaining how an automatic configuration works.

FIG. 1 shows a first exemplary embodiment of a power automation installation 10. The power automation installation 10 comprises an installation control device 11 which is connected via a concentrator device 12 to a plurality of power automation devices 13a through 13d. The power automation devices 13a through 13d can be electrical measuring instruments, power quality devices, smart meters, actuators such as e.g. intelligent switching devices, protection devices or control devices. Such power automation devices can be referred to collectively as IEDs (Intelligent Electronic Devices) and in general serve the purpose of acquisition of a state of a state value describing an electrical power supply network and/or influencing the electrical power supply network. To this end said IEDs are ordinarily arranged in direct proximity to the components of the power supply network they are monitoring or influencing. The electrical power supply network itself is not shown in FIG. 1 for the sake of better clarity.

In the case of the power automation installation 10 according to FIG. 1 it can for example be a (classical) power automation installation for controlling and monitoring switchgear or a transformer station in the electrical power supply network. In this case the power automation installation 10 ordinarily comprises a comparatively manageable number of power automation devices (for example 10 to 100 devices). The power automation installation 10 can however also be a power automation installation used within the framework of so-called Smart Grid Applications for controlling and monitoring a distribution grid of an electrical power supply system, wherein this distribution grid section is ordinarily arranged in the medium voltage and lower voltage range of the power supply network. Along with the classical energy consumers, with such smart grid applications distribution grid in the medium voltage and low voltage level energy producers (for example a photovoltaic installation on the roof of a single family dwelling or a biogas installation of an agrarian operation) or so-called prosumers can also be provided, said prosumers constituting a combination of energy producers (producers) and energy consumers (consumers). Since such units occur in great number in an electrical power supply network, a power automation installation has correspondingly many power automation devices which are assigned to the individual producers, consumers or prosumers; such a power automation installation can for example have 10,000 to 1,000,000 power automation devices.

The task of the concentrator device 12 is to act somewhat as a connector between the installation control device 11 and the individual power automation devices 13a through 13d and on the one hand to collect information about changes of state of the individual power automation devices (for example the change of a switch setting from open to closed) and on the other hand to make this information available in suitable form to the installation control device 11. The concentrator device 12 hence constitutes both communications technology and also a logical representative of several power automation devices vis-à-vis the installation control device.

This principle is to be explained by way of example with reference to FIG. 2. To this end FIG. 2 shows three power automation devices which are labeled “IED 01”, “IED 02”, and “IED 03”. These power automation devices are supposed to be the power automation devices 13a, 13b and 13c according to FIG. 1. Furthermore, FIG. 2 shows a concentrator device named “KON” which can be the concentrator device 12 according to FIG. 1. The power automation device 13a comprises different device functions which can be reproduced in the device software of the power automation device 13a by a device description 21 with a data model. The device description 21 of the power automation device 13a has according to FIG. 2 only two data objects, “DAT 01” and “DAT 02”, which in turn can occupy different states. For example the power automation device 13a can be an electrical measuring instrument which records an electrical current at a measuring point of the electrical power supply network. The first data object “DAT 01” can then for example be the value of the measured current, while the second data object “DAT 02” describes an operating state of the electrical power automation device 13a. The data object “DAT 01” can thus, corresponding to the measured current assume different numeric values, while the second data object “DAT 02” can for example assume the states “active”, “standby”, “maintenance”, “test” or “error”.

In a corresponding manner, the further power automation devices 13b and 13c have a respective device description with their own data objects, likewise labeled “DAT 01” and “DAT 02”, said data objects being in turn able to occupy different states.

The concentrator device 11 comprises a (not explicitly shown in FIG. 2) data storage device in which a data model file is stored, said file specifying a data model 22 of the concentrator device 12. The concentrator data model 22 comprises specifications about the power automation devices 13a-c connected to the concentrator device 12, in addition their functions and settings, and comprises in addition information about the states of the individual power automation devices 13a-c, by reproducing the individual data objects of the respective power automation devices 13a-c and adapting them to the respective state of the corresponding data objects of the power automation devices 13a-c.

As can be inferred from FIG. 2, the concentrator data model 22 for example has entries corresponding to the data objects “DAT 01” and “DAT 02” of the first power automation device 13a, said entries being labeled “IED 01_DAT 01” or “IED_DAT 02”. Corresponding entries are present for the data objects of the remaining power automation devices 13b and 13c. In this way, on the one hand a specification can be made via the structure of the concentrator data model 22 about the power automation devices connected to the concentrator device 12 as well as their functions and on the other hand a precise image of the states of the individual data objects of the respective power automation devices can be reproduced.

Changes of state of the individual data objects of the power automation devices 13a-c are entered in the device descriptions of the individual field devices and are reported to the concentrator data model. This can for example take place in an event-driven manner whenever a change of the state of individual data objects occurs, or can take place on a regular basis in the case of an update of the state of a data object, thus also when no change of state has occurred. In a corresponding manner changes of state or updates are transmitted to the installation data model.

In analogy to the described mode of operation, control commands can also be transmitted from the installation control device to the power automation devices by purposefully changing state values in the installation data model and transmitting this change via a corresponding adaptation of the concentrator data model to the device descriptions of the power automation devices affected by the change. Such control actions can of course only be carried out with suitable data objects (e.g. switch position) of power automation devices set up for this purpose (e.g. switching devices).

For example the device descriptions of the individual power automation devices 13a-c can be ICD files (Intelligent Electronic Device Capability Description) structured in accordance with the IEC 61850 standard or IID files (Instantiated IED Description) and the concentrator data model can be an SCD file (substation configuration description) structured in accordance with the IEC 61850 standard, said SCD file using the so-called substation configuration language (SCL) to specify structured information about structure, functions and states of the respective power automation devices. However, it is also possible that the device descriptions are not specified in an SCL-based structured file.

As indicated by an arrow 23 in FIG. 2, the concentrator device 12 makes its concentrator data model 22 available to the higher-level installation control device (not shown in FIG. 2 for clarity's sake). The installation control device has an installation data model that comprises information about all power automation devices of the power automation installation corresponding to the statements made about the configuration data model. The installation model consequently also has information about further power automation devices that are not connected to the installation control device via the described concentrator device 12, for example because they are connected via further concentrator devices or are connected directly to the installation control device. The installation data model can likewise be an SCD file structured in accordance with the IEC 61850 standard. Vis-à-vis the installation control device the concentrator device in turn represents itself SCL-based as ICD or IID. In the adjustment of the subordinate power automation devices the configuration file can be specified in the concentrator device as SCD description.

FIG. 3 shows a second exemplary embodiment of a power automation installation 30 which on the one hand has two (e.g. executed redundant to one another) installation control devices 31a and 31b as well as several power automation devices 32. The power automation devices 32 are connected to the installation control devices 31a and 31b via a cascade of three concentrator devices 33a, 33b, and 34, wherein the concentrator devices 33a and 33b form a lower hierarchy level and the concentrator device 34 is superordinate to concentrator devices 33a and 33b. Such cascaded arrangements of concentrator devices can be used, in particular in the case of power automation installations with a great number of power automation devices 32, which are arranged in a widely dispersed manner. The operation corresponds however essentially to the operation explained in FIG. 1; here only one further transmission level is to be considered due to the cascade arrangement of the concentrator devices.

To ensure a proper operation of the power automation installation, all components, so in particular the concentrator device and the installation control device, must be adapted by corresponding configuration to the actual circumstances, in particular to the actual power automation devices currently connected to the concentrator device. Using FIG. 4 an exemplary embodiment will now be explained, as to how, in particular in power automation installations with a very large number of power automation devices, an adaptation of the configuration of both the concentrator device as well as also of the installation control device can be performed efficiently without having to interrupt the operation of the power automation installations.

To this end FIG. 4 shows the comparatively simple power automation installation 10 in accordance with FIG. 1, which comprises the installation control device 11, the concentrator device 12 as well as first the three power automation devices 13a, 13b and 13c. The power automation installation 10 can be operated in this structure, i.e. the configuration of both the concentrator device 12 as well as also of the installation control device 11 is adapted to the individual power automation devices 13a-c as well as their functions and settings, and the individual states of the data objects of the respective power automation devices 13a-c can be passed on both to the concentrator device 12 as well as also to the installation control device 11 (and to the control if necessary in the opposite direction).

For the following statements it should now be assumed that an additional power automation device 13d of the power automation installation 10 should be added, for example in order to integrate a new electric power meter (e.g. a “smart meter”) into the power automation installation 10. In addition it should be assumed that the individual components of the power automation installation 10 are set up for communication in accordance with the IEC 61850 standard, in the process the power automation devices 13a-c and 13d have IEC 61850 server functionality, the concentrator device has both IEC 61850 client functionality and also IEC 61850 server functionality and the installation control device has IEC 61850 client functionality. The additional power automation device 13d has a unique device code and the IEC device description of the additional power automation device 13d has at least one IEC 61850 data object which is compatible with the installation data model of the installation control device 11, thus e.g. is stored as type in the installation control device 11. As an alternative however the case can also occur that the data objects are not specified in an SCL-based structured file. The concentrator device 12 has a concentrator data model 46 that first comprises data objects 46a of power automation devices 13a-c which are already present. The power automation installation 10 is in operating mode. Adaptation of the configuration of the concentrator device 12 and of the installation control device 11 works in the following manner:

First the device code 41 of the additional power automation device 13d is stored by user input in the installation control device. Then the power automation device 13d physically connects to the network of the concentrator device 12. After that the concentrator device 12 generates an IEC 61850 network address, assigns said address to the additional power automation device 13d (e.g. via a DHCP method) and transmits the address 42 to the additional power automation device 13d. The additional power automation device 13d now uses this address for further communication with the concentrator device 12.

After that, the concentrator device 12 reads the device code 43 of the additional power automation device 13d (e.g. via IEC 61850 from a typed “nameplate information” on the basis of an IEC 61850 profile) from the additional power automation device 13d (this can for example take place via an FTP or MMS file transfer) and sends this device code 43 to the installation control device 11, which compares it with the device code 41 predefined via user input. In case both device codes 41 and 43 match the installation control device 11 sends a confirmation telegram 44 to the concentrator device 12. Only when the confirmation telegram 44 is present does the concentrator device read a device description file 45 (e.g. in the form of an ICD file or an IID file pursuant to IEC 61850) from the additional power automation device 13d and inserts the data objects contained in the device description 45 as additional data objects 46b in its concentrator data model 46.

As an alternative to the described procedure, the provision of the device description file in the concentrator device can also take place via a so-called discovery service. In this connection the concentrator device itself uses a collection service which determines the necessary information for the device description file via individual queries and compiles this information into a device description file. This is in particular suitable when the data objects of the power automation devices are not available in SCL-based structured form (e.g. as ICD or IID).

The concentrator device 12 then reports to the installation control device 11 that the concentrator data model 46 has been changed and is ready for readout. The installation control device 11 reads the newly added data objects 46b of the additional power automation device 13d from the concentrator device 12 and examines these data objects 46b with respect to compatibility with its own installation data model 47, for example by comparing the data objects 46b with the stored types of the installation data model 47. In the event of existing compatibility the installation control device 11 confirms the consistency of the new data objects 46b and thus the operational readiness of the power automation installation 10 in the amended form by sending an activation telegram 48 to the concentrator device 12.

In the event of an existing activation telegram 48 the concentrator device 12 integrates the additional power automation device 13d actively into the operation of the power automation installation 10, whereby the configuration settings are concluded.

To be taken into consideration is the fact that the input and checking of the device code of the additional power automation device 13d as well as the compatibility check of the added data objects with the installation data model constitute advantageous, but optional embodiments of the described method.

In the event of the removal of a power automation device, the entries of the respective data objects are correspondingly deleted in the concentrator data model and the installation data model or are set to inactive.

In summary, in the case of the application of the inventive method the following advantages arise: through an automatic configuration of the concentrator device the manual configuration is dispensed with and the engineering effort is reduced in the event of changes to the overall system configuration. The automatic configuration takes place at runtime of the power automation installation. Thus the overall function of the concentrator device and of the installation control device is not impaired. The engineering on file basis (with IEC 61850 e.g. in the form of a substation configuration description (SCD)) is omitted and the imports and exports of the configuration files associated with it are avoided.

1-9. (canceled)

10. A method of operating a power automation installation, the power automation installation having:
a plurality of power automation devices and at least one higher-level installation control device for controlling and/or monitoring the power automation devices, wherein the power automation devices are connected to the installation control device by a concentrator device and a data model file containing a concentrator data model is stored in a memory of the concentrator device and wherein the concentrator data model contains information about the power automation devices connected to the concentrator device, their functions and settings, and also provides data objects the states of which are adapted to current states of corresponding data objects of the power automation devices, and
the method comprising the following steps:
connecting an additional power automation device to the concentrator device;
generating a communication address for the additional power automation device by the concentrator device and transmitting the communication address to the additional power automation device;
storing the communication address in the additional power automation device and using the communication address for further communication with the concentrator device;
retrieving a device description file of the power automation device by the concentrator device, the device description file specifying functions and settings of the additional power automation device;
adapting the concentrator data model to the functions and settings of the additional power automation device specified by the device description file; and
providing the adapted concentrator data model for the installation control device.

11. The method according to claim 10, which comprises:
recording, by the installation control device, a user input prior to connecting the additional power automation device to the concentrator device, the user input specifying a device code of the additional power automation device;
after connection of the additional power automation device to the concentrator device, transmitting from the additional power automation device a device code thereof to the concentrator device;
sending with the concentrator device the device code transmitted by the additional power automation device to the installation control device;
checking, by the installation control device, whether the device code transmitted by the concentrator device matches the device code entered by the user and, in the case of a matching device code, sending a confirmation telegram to the concentrator device; and
subsequently retrieving, by the concentrator device, the device description file from the additional power automation device only after the confirmation telegram is on hand.

12. The method according to claim 10, wherein:
the installation control device comprises an installation data model file containing an installation data model, the installation data model providing information about all power automation devices of the power automation installation whose functions and settings comprise as well as provide data objects, whose states are adapted to the current states of corresponding data objects of the power automation devices;
the installation control device adapts the installation data model thereof to the functions and settings of the additional power automation device specified by the concentrator data model; and
in the operation of the power automation installation, a change of state of a data object of a power automation device connected to the concentrator device brings about a corresponding change of the states of the corresponding data objects of the concentrator data model and of the installation data model.

13. The method according to claim 12, which comprises:
first checking with the installation control device the information contained in the concentrator data model about functions and settings of the additional power automation device to determine whether the functions and settings are compatible with the installation data model;
adapting with the installation control device the installation data model to the concentrator data model and sending an activation telegram to the concentrator device only in the event of existing compatibility; and
integrating the additional power automation device in the operation of the power automation installation only if an activation telegram has been received.

14. The method according to claim 10, which comprises:
on occasion of a removal of a power automation device from the power automation installation, detecting by the concentrator device a missing connection to the removed power automation device and adapting the concentrator data model by deleting entries for the removed power automation device and transmitting an adapted concentrator data model to the installation control device; and
adapting an installation data model of installation control device by deleting the entries for the removed power automation device.

15. The method according to claim 10, wherein the device description file of the power automation device and of the additional power automation device is specified in the form of an ICD file or IID file in accordance with the IEC 61850 standard.

16. The method according to claim 10, wherein the concentrator data model of the concentrator device is specified in the form of an SCD file in accordance with the IEC 61850 standard.

17. The method according to claim 12, wherein the installation data model of the installation control device is specified in the form of an SCD file in accordance with the IEC 61850 standard.

18. A power automation installation, comprising:
a plurality of power automation devices and at least one installation control device for controlling and/or monitoring the power automation devices;
a concentrator device connecting said power automation devices with said installation control device;
wherein said at least one installation control device and said concentrator device of the power automation installation are configured for carrying out the method according to claim 10.
